(19) United States
(12) Patent Application Publication
(10) Pub. No.: US 2016/0208613 A1
(43) Pub. Date: Jul. 21, 2016

(54) GAS TURBINE ENGINE INTEGRALLY BLADED ROTOR

(71) Applicant: United Technologies Corporation, Hartford, CT (US)

(72) Inventor: Christopher L. Potter, East Hampton, CT (US)

(21) Appl. No.: 14/597,553

(22) Filed: Jan. 15, 2015

(51) Int. Cl. F01D 5/06; F01D 11/12; F01D 9/04

(52) U.S. Cl. CPC F01D 5/06; F01D 9/041; F01D 11/12; F05D 2220/32; F05D 2240/55; F05D 2240/20

(57) ABSTRACT

A rotor disk includes a web that extends from a rim radially inward to a bore. A spacer is integral with and extending generally axially from the rim. The spacer includes a flow path surface adjacent to an end wall of the rim. An inner surface is spaced radially inwardly from the flow path surface and extends between first and second axial locations. A fillet interconnects the inner surface and the web. The inner surface is tangent to the fillet at the first axial location. The second axial location axially aligns beneath vanes and surrounded by the inner surface. The spacer has first and second radial thicknesses respectively disposed at the first and second axial locations. The first and second radial thicknesses are different than one another. The spacer is at least partially tapering axially between the first and second axial locations.

### BACKGROUND

This disclosure relates to an integrally bladed rotor for a gas turbine engine.

A gas turbine engine typically includes a fan section, a compressor section, a combustor section and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

One type of compressor section includes a stack of rotor disks. Some of these disks may include integrally bladed rotors that are integrally formed with a rim of the disk. The blade and rim create centrifugal loads on the bore and web of the disk that may affect the life of the rotor disk.

### SUMMARY

In a further embodiment of any of the above, a rotor disk includes a web that extends from a rim radially inward to a bore. A spacer is integral with and extending generally axially from the rim. The spacer includes a flow path surface adjacent to an end wall of the rim. An inner surface is spaced radially inwardly from the flow path surface and extends between first and second axial locations. A fillet interconnects the inner surface and the web. The inner surface is tangent to the fillet at the first axial location. The second axial location axially aligns beneath vanes and surrounded by the inner surface. The spacer has first and second radial thicknesses respectively disposed at the first and second axial locations. The first and second radial thicknesses are different than one another. The spacer is at least partially tapering axially between the first and second axial locations.

In a further embodiment of the above, a circumferential array of blades is integrally mounted to the end wall.

In a further embodiment of any of the above, the web and bore are integral with and axially aligned with the blades.

In a further embodiment of any of the above, the spacer includes a recess filled with a rub strip that provides the flow path surface. The rub strip is adjacent to tips of the vanes.

In a further embodiment of any of the above, the spacer includes an axial end with an annular notch. An adjacent rotor disk engages the annular notch.

In a further embodiment of any of the above, the rim includes an annular groove on a side opposite the spacer. A hub engages the annular groove and is secured to a shaft.

In a further embodiment of any of the above, the first thickness is smaller than the second thickness.

In a further embodiment of any of the above, one of the first and second thicknesses is in a range of 50%-95% of the other of the first and second thicknesses.

In a further embodiment of any of the above, the range is 75%-95%.

In a further embodiment of any of the above, the first and second axial locations are spaced an axial length from one another. The length is 3-5 times the greater of the first and second thicknesses.

In another exemplary embodiment, a gas turbine engine includes a turbine section. A compressor section is arranged upstream from the turbine section. The compressor section includes a stack with an integrally bladed rotor disk. The rotor disk is arranged axially adjacent to a fixed stage of vanes. The rotor disk includes a web that extends from a rim radially inward to a bore. A spacer is integral with and extending generally axially from the rim. The spacer includes a flow path surface adjacent to an end wall of the rim. An inner surface is spaced radially inwardly from the flow path surface and extends between first and second axial locations. The flow path surface is configured to seal relative to a fixed stage of vanes. A fillet interconnects the inner surface and the web. The inner surface is tangent to the fillet at the first axial location. The second axial location axially aligns beneath the vanes and is surrounded by the inner surface. The spacer has first and second radial thicknesses respectively disposed at the first and second axial locations. The first and second radial thicknesses are different than one another. The spacer is at least partially tapering axially between the first and second axial locations.

In a further embodiment of any of the above, the compressor section includes a low pressure compressor and a high pressure compressor that is arranged downstream from the low pressure compressor. The rotor disk is arranged in the high pressure compressor.

In a further embodiment of any of the above, the stack includes multiple rotating stages. The rotor disk provides a last rotating stage in the stack. A hub engages the rim and is secured to a shaft.

In a further embodiment of any of the above, the web and bore are integral with and axially aligned with the blades.

In a further embodiment of any of the above, the rub strip is adjacent to tips of the vanes.

In a further embodiment of any of the above, the spacer includes an axial end with an annular notch. An adjacent rotor disk engages the annular notch.

In a further embodiment of any of the above, the first thickness is smaller than the second thickness.

In a further embodiment of any of the above, one of the first and second thicknesses is in a range of 50%-95% of the other of the first and second thicknesses.

In a further embodiment of any of the above, the range is 75%-95%.

In a further embodiment of any of the above, the first and second axial locations are spaced an axial length from one another. The length is 3-5 times the greater of the first and second thicknesses.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is a broken cross-sectional view of a compressor section stack of the engine in FIG. 1.

FIG. 3 is an enlarged cross-sectional view of a rotor disk embodiment from the stack of FIG. 2.

FIG. 4 is an enlarged view of a spacer integrally formed with the rotor disk of FIG. 3.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

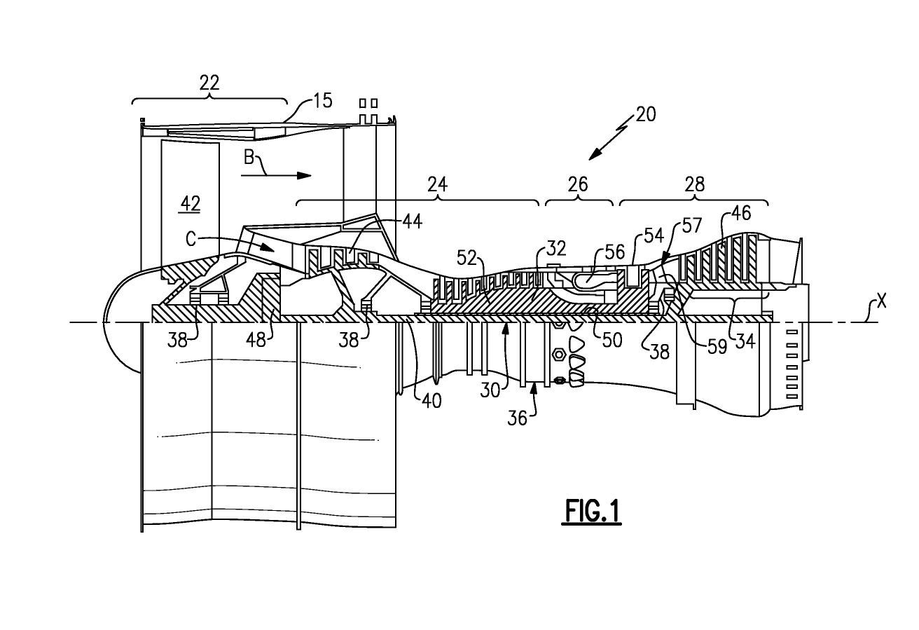

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis X which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

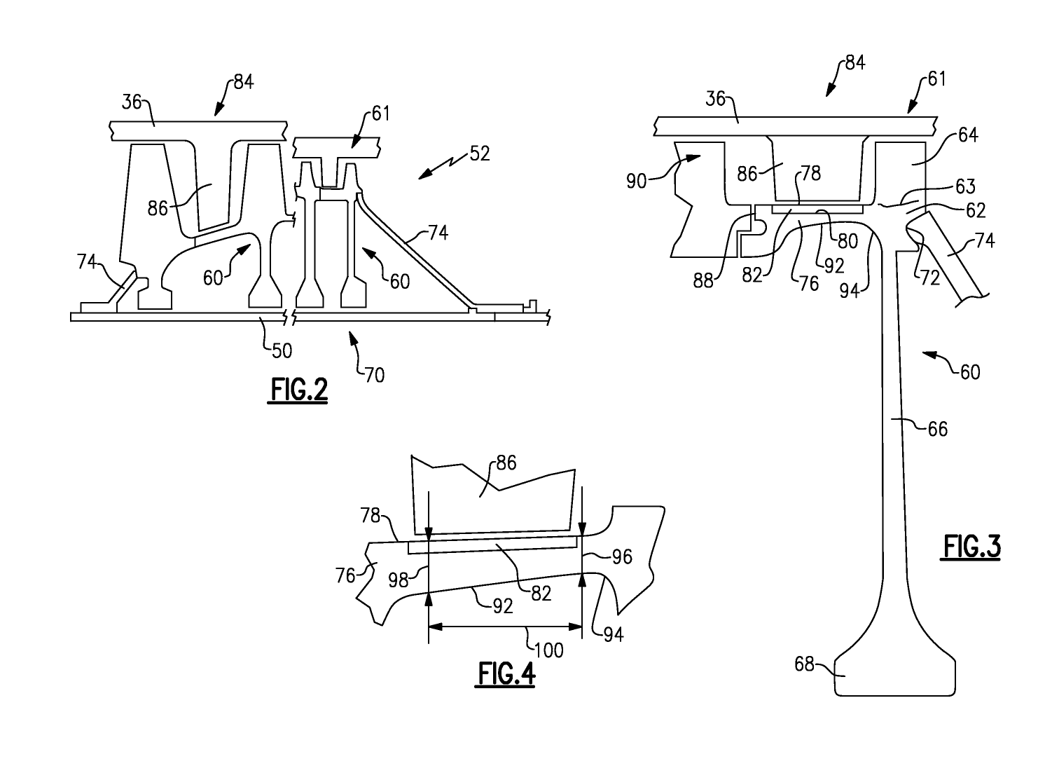

Referring to FIG. 2, an example high pressure compressor 52 is shown in more detail. The high pressure compressor 52 is provided by a stack 70 of rotor disks 60 mounted to the outer shaft 50. The rotor disks 60 are clamped between hubs 74. Fixed stages 84 are supported by the engine static structure 36 and arranged between rotating stages 61 provided by the rotor disks 60.

Referring to FIG. 3, at least one rotor disk 60 includes a rim 62 integral with a web 66 extending radially inward to a bore 68. The rim 62 provides an end wall 63 from which integral blades 64 extend. The integrally bladed rotor disk is machined from a solid forging of titanium or nickel alloy, for example.

In the example, the rotor disk 60 provides the last stage of the high pressure compressor 52. It should be understood that the rotor disk 60 may be provided at other locations within the stack 70. An annular groove 72 is provided at an aft side of the rim 62. The hub 74 engages the groove 72 to clamp the stack.

A spacer 76 is integral with the rim 62 and extends axially from a side opposite the annular groove 72. In one example, the spacer 76 includes an annular notch 88 that is configured to cooperate with and engage an adjacent rotor disk 90. The spacer 76 provides a flow path surface 78 that seals relative to a tip of vanes 86 of the fixed stage 84. The spacer 76 includes an annular recess 80 that is filled with a rub strip 82 to provide the flow path surface 78.

The spacer 76 includes an inner surface 92 opposite the flow path surface 78. The inner surface 92 adjoins a fillet 94 that interconnects the inner surface 92 to the web 66. The inner surface 92 is tangent to the fillet at a first axial location. A second axial location is axially aligned beneath the vanes 86 and is surrounded by the inner surface, as best shown in FIG. 4. That is, in the example embodiment, the second axial location is not adjacent to a film cooling hole through the spacer 76. The spacer 76 has first and second radial thicknesses 96, 98 that respectively correspond to the first and second axial locations. The first and second thicknesses 96, 98 are different than one another such that the spacer 76 at least partially tapers axially between the first and second axial locations. In the example, the first thickness 96 is smaller than the second thickness 98 such that the spacer 76 tapers toward the web 66. However, it should be understood that the second thickness 98 may be smaller than the first thickness 96 if desired.

In one example, one of the first and second thicknesses 96, 98 is in the range of 50%-95% of the other the first and second thicknesses 96, 98, and in another example, the range is 75%-95%. The first and second axial locations are spaced in axial length 100 from one another. The length 100 is 3-5 times the greater of the first and second thicknesses 96, 98 in one embodiment.

By contouring the spacer 76, mass can be removed in areas where stresses are low. Reducing mass outboard of the part self-sustaining radius decreases the centrifugal loads on the bore and web 66, 68 thereby increasing the cycle life of the rotor disk 60.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A gas turbine engine rotor stack comprising:
a rotor disk including:
a web extending from a rim radially inward to a bore, and
a spacer integral with and extending generally axially from the rim, the spacer including:
a flow path surface adjacent to an end wall of the rim,
an inner surface spaced radially inwardly from the flow path surface and extending between first and second axial locations, the flow path surface configured to seal relative to a fixed stage of vanes,
a fillet interconnecting the inner surface and the web, the inner surface tangent to the fillet at the first axial location, and the second axial location axially aligning beneath the vanes and surrounded by the inner surface,
the spacer having first and second radial thicknesses respectively disposed at the first and second axial locations, the first and second radial thicknesses different than one another, and
the spacer at least partially tapering axially between the first and second axial locations.

2. The rotor stack according to claim 1, comprising a circumferential array of blades integrally mounted to the end wall.

3. The rotor stack according to claim 2, wherein the web and bore are integral with and axially aligned with the blades.

4. The rotor stack according to claim 1, wherein the spacer includes a recess filled with a rub strip that provides the flow path surface, the rub strip adjacent to tips of the vanes.

5. The rotor stack according to claim 1, wherein the spacer includes an axial end with an annular notch, and an adjacent rotor disk engages the annular notch.

6. The rotor stack according to claim 1, wherein the rim includes an annular groove on a side opposite the spacer, and a hub engages the annular groove and is secured to a shaft.

7. The rotor stack according to claim 1, wherein the first thickness is smaller than the second thickness.

8. The rotor stack according to claim 1, wherein the one of the first and second thicknesses is in a range of 50%-95% of the other of the first and second thicknesses.

9. The rotor stack according to claim 8, wherein the range is 75%-95%.

10. The rotor stack according to claim 8, wherein the first and second axial locations are spaced an axial length from one another, wherein the length is 3-5 times the greater of the first and second thicknesses.

11. A gas turbine engine comprising:
a turbine section;
a compressor section arranged upstream from the turbine section, the compressor section includes a stack with an integrally bladed rotor disk, the rotor disk arranged axially adjacent to a fixed stage of vanes, the rotor disk including:
a web extending from a rim radially inward to a bore, and
a spacer integral with and extending generally axially from the rim, the spacer including:
a flow path surface adjacent to an end wall of the rim,
an inner surface spaced radially inwardly from the flow path surface and extending between first and second axial locations, the flow path surface configured to seal relative to a fixed stage of vanes,
a fillet interconnecting the inner surface and the web, the inner surface tangent to the fillet at the first axial location, and the second axial location axially aligning beneath the vanes and surrounded by the inner surface,
the spacer having first and second radial thicknesses respectively disposed at the first and second axial locations, the first and second radial thicknesses different than one another, and
the spacer at least partially tapering axially between the first and second axial locations.

12. The engine according to claim 11, wherein the compressor section includes a low pressure compressor and a high pressure compressor arranged downstream from the low pressure compressor, the rotor disk arranged in the high pressure compressor.

13. The engine according to claim 12, wherein the stack includes multiple rotating stages, the rotor disk provides a last rotating stage in the stack, and a hub engages the rim and is secured to a shaft.

14. The engine according to claim 11, wherein the web and bore are integral with and axially aligned with the blades.

15. The engine according to claim 11, wherein the spacer includes a recess filled with a rub strip that provides the flow path surface, the rub strip adjacent to tips of the vanes.

16. The engine according to claim 11, wherein the spacer includes an axial end with an annular notch, and an adjacent rotor disk engages the annular notch.

17. The engine according to claim 11, wherein the first thickness is smaller than the second thickness.

18. The engine according to claim 11, wherein the one of the first and second thicknesses is in a range of 50%-95% of the other of the first and second thicknesses.

19. The engine according to claim 18, wherein the range is 75%-95%.

20. The engine according to claim 18, wherein the first and second axial locations are spaced an axial length from one another, wherein the length is 3-5 times the greater of the first and second thicknesses.
